(19) United States
(12) Patent Application Publication
(10) Pub. No.: US 2010/0039594 A1
(43) Pub. Date: Feb. 18, 2010

(54) METHOD OF MAKING SMART CARDS, SMART CARDS MADE ACCORDING TO THE METHOD, AND AN LCD PARTICULARLY FOR USE IN SUCH SMART CARDS

(75) Inventors: Gady Golan, Hod-HaSharon (IL); Dany Moskovitch, Haifa (IL)

Correspondence Address: MARTIN D. MOYNIHAN d/b/a PRTSI, INC., P.O. BOX 16446, ARLINGTON, VA, 22215, US

(73) Assignee: Micro-D Ltd., Nazareth IIit (IL)

(21) Appl. No.: 12/375,538

(22) PCT Filed: Jul. 31, 2007
(86) PCT No.: PCT/IL07/00960

§ 371 Date: Oct. 27, 2009

Related U.S. Application Data
(60) Provisional application No. 60/834,560, filed on Aug. 1, 2006.

(51) Int. Cl. G02F 1/1333; B29C 65/02; G06K 19/067

(52) U.S. Cl. 349/122; 156/211; 235/488

(57) ABSTRACT

A method of making a thin flexible smart card having a printed circuit board (PCB) including a liquid crystal display (LCD) thereon, the PCB and LCD being embedded within a laminate of plastic layers, comprising producing an initial laminate by subjecting a plurality of plastic layers to a relatively high temperature and pressure for a relatively long period of time, producing a cavity in one face of the initial laminate, but terminating short of the opposite face, the cavity being configured and dimensioned to accommodate said PCB and LCD thereon, introducing the PCB and LCD into the cavity from one face of the initial laminate with the LCD facing said opposite face thereof, applying one or more further plastic layers over the one face of the initial laminate to cover the PCB in the cavity, and subjecting the initial laminate and the plastic layers to a low temperature, applied to the side of the further plastic layers at a lower pressure and for a shorter period of time than used in producing the initial laminate, to produce the laminate of plastic layers with the PCB and LCD embedded therein.

### FIELD AND BACKGROUND OF THE INVENTION

The present application relates to a method of making thin flexible smart cards having a PCB including an LCD thereon, both embedded within a laminate of plastic layers. The invention also relates to a smart card made according to the above method, and further, to an LCD particularly useful in such smart cards.

Smart cards, or identification cards, are increasingly being used for making financial transactions, for providing access to premises, and for integrating personal information. Currently, smart cards are divided into two families: contact-type and contact-less type. Both families generally include integrated circuits having passive built-in flash memories which require an energy source for the Read/Write process, and for the status verification process. In contact-type cards, the energy source is an external stationary energy source energizing the electronic components, including the built-in flash memories, via the contacts; whereas the contact-less types include an RFID (radio frequency identification) unit, plus an antenna, for energizing the electronic components in the card.

Various standards have been developed by the International Organization for Standardization, called ISO Standards, for the two different types of smart cards. For example, ISO-7816 has been developed for smart cards including integrated circuits with contacts; and ISO-14443 has been developed for smart cards including integrated circuits with contacts. The ISO standards specify stringent structural and performance requirement, and particularly dimensional tolerances, for the respective cards, which are extremely difficult to meet, especially in a method capable of producing the smart cards in volume and at relatively low cost.

For example, the known problems in embedding electronic circuits (PCBs) in smart cards meeting the ISO standards include the following difficulties:

1. Lamination of PVC sheets to each other;

2. Bonding a solder mask due to its oily characteristics (solder mask is used to passivate copper conducts on PCBs and reject soldering iron from spreading on top of the PCB);

3. Preventing voids and air pockets within the produced card;

4. Keeping the card flat and flexible after hot lamination;

5. Flattening the PCB surface without damaging the electronic components sometimes connected by wire bonding (75 gr. Tearing force ISO-9002 and ISO-14001); and

6. Bonding the battery contacts to the PCB's conductors due to the required flexibility and shearing force in through-holes.

It is particularly difficult to produce a satisfactory smart card including an LCD (liquid crystal display) because of the high sensitivity of LCDs to high temperature and pressure used in the normal lamination process for making such cards.

### OBJECTS AND BRIEF SUMMARY OF THE PRESENT INVENTION

On object of the present invention is to provide a method of making a thin flexible smart card having advantages in one or more of the above respects. Another object of the invention is to provide a smart card including a novel LCD; and a further object of the invention is to provide a novel LCD particularly useful in smart cards.

According to one aspect of the present invention, there is provided a method of making a thin flexible smart card having a printed circuit board (PCB) including a liquid crystal display (LCD) thereon, said PCB and LCD thereon being embedded within a laminate of plastic layers, comprising:

producing an initial laminate by subjecting a plurality of plastic layers to a relatively high temperature and pressure for a relatively long period of time;

producing a cavity in one face of said initial laminate, but terminating short of the opposite face, said cavity being configured and dimensioned to accommodate said PCB and LCD included thereon;

introducing said PCB and said LCD into said cavity from said one face of the initial laminate with the LCD facing said opposite face thereof;

applying one or more further plastic layers over said one face of the initial laminate to cover said PCB in said cavity;

and subjecting said initial laminate and said one or more further plastic layers to a low temperature, applied to the side of said further plastic layers, at a lower pressure and for a shorter period of time than used in producing the initial laminate, to produce said laminate of plastic layers with said PCB and LCD embedded therein.

It will thus be seen that the method involves a two-step lamination process, wherein the first step utilizes the relatively high temperature and pressure, and the relatively long time period, for producing an initial laminate including the PCB and the temperature-sensitive LCD; whereas the second lamination step, applied after the PCB and LCD have been introduced into the initial laminate, utilizes a lower temperature, a lower pressure, and a shorter time period, which the PCB and LCD can better tolerate without damage.

According to further features in the described preferred embodiment, a film of a solid adhesive is applied to the one face of the initial laminate, before the PCB and LCD are introduced into the cavity, to extend into the cavity between the surfaces thereof and the PCB and LCD when introduced therein; the film of solid adhesive being of a thickness to bond the one or more plastic layers to the one face of the initial laminate, and to fill voids between the PCB, the LCD, and the surfaces of the cavity, when the initial laminate and the one or more further plastic layers are subjected to the lower temperature and pressure for the shorter period of time.

Preferably, in the described preferred embodiments, two such films of solid adhesive are applied, one overlying the PCB and LCD, and the other underlying the PCB, which are effective, not only to firmly bond the plastic layers together with the PCB and LCD embedded therein, but also to fill all the voids between the PCB, the LCD, and the surface of the cavity, thereby preventing the formation of trapped air bubbles. The use of one or two films of such solid adhesive, as described above, has further been found to reduce the possibility of corrosion (passivation), and to enhance the flexibility of the smart card including the PCB and LCD embedded therein. A preferred film of solid adhesive is one of an acrylic resin, such as one supplied by J. Huerta, China, Adhesive PLJ-BOND DESIGN 1000, Catalog No. LNR-RR#101005A-1 ADH-RR#091505I-1.

In the described preferred embodiment, the plastic layers are of polyvinyl chloride. The initial laminate is constituted of a first plastic layer of 30-50 microns, preferably 40 microns; a second plastic layer of 135-165 microns, preferably 150 microns; a third plastic layer of 225-275 microns, preferably 250 microns; and a fourth plastic layer of 225-275, preferably 250 microns. Also, the one or more further plastic layers include a fifth layer of 105-135 microns, preferably 120 microns; and a sixth plastic layer of 30-50 microns, preferably 40 microns.

According to further features in the preferred embodiment of the invention described below, the relatively high temperature used in producing the initial laminate is preferably 110-135° C., most preferably 120° C.; the relatively high pressure in making the initial laminate is preferably 12-16 Kg/cm², most preferably 14 Kg/cm²; and the relatively long time period used in the initial lamination process is preferably 25-35 minutes, most preferably 30 minutes. In addition, the lower temperature used in the second lamination step is preferably 90-105° C., most preferably 100° C.; the pressure is preferably 0.3-0.8 Kg/cm², most preferably 0.5 Kg/cm²; and the time period is preferably 0.3-0.8 minutes, most preferably 0.5 minutes.

According to another feature in the preferred embodiment of the invention described below, the produced laminate of plastic layers, with the PCB and LCD embedded therein, is milled on a face with mills communicating with the PCB; and electrical contact strips coated with an electrically-conductive adhesive are applied in the mills grooves and electrically connected to the PCB via the electrically-conductive adhesive.

According to a still further feature, the PCB further includes a smart chip and a button switch electrically connected to the PCB and embedded therewith in the laminate.

According to a still further feature in the described preferred embodiment, the LCD included on the PCB comprises two PET (polyethylene terathyalate) layers, two optically clear (OC) coatings on indium tin oxide (ITO) polyester film, (with a resistance of 50 to 100 ohms/sq, and optical anisotropic property), and one reflective layer.

According to another aspect of the present invention, there is provided a thin flexible smart card comprising a laminate of plastic layers, and a PCB including an LCD thereon, both embedded within the laminate of plastic layers; the LCD comprising: two PET (polyethylene terathyalate) layers, two optically clear (OC) coatings on indium tin oxide (ITO) polyester film, and a reflective layer.

According to a still further aspect of the present invention, there is provided an LCD comprising two PET (polyethylene terathyalate) layers, two optically clear (OC) coatings on indium tin oxide (ITO) polyester films, and a reflective layer.

Further features and advantages of the invention will be apparent from the description below.

### BRIEF DESCRIPTION OF THE DRAWINGS

The invention is herein described, by way of example only, with the reference to the accompanying drawings, wherein:

FIG. 1 is a side elevational view, partly exploded, schematically illustrating one form of smart card constructed in accordance with the present invention;

FIG. 2 is a side elevational view schematically illustrating the LCD (liquid crystal display) carried by the PCB (printed circuit board) in the smart card of FIG. 1; and

FIG. 3 is an exploded 3-dimensional view illustrating the various layers in the smart card of FIG. 1.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

The smart card illustrated in the drawings is a contact-type card, subject to ISO-7816 standards. As will be described below, the illustrated smart card is capable of meeting the stringent structural and performance requirements, and particularly the dimensional tolerances, as specified in ISO-7816.

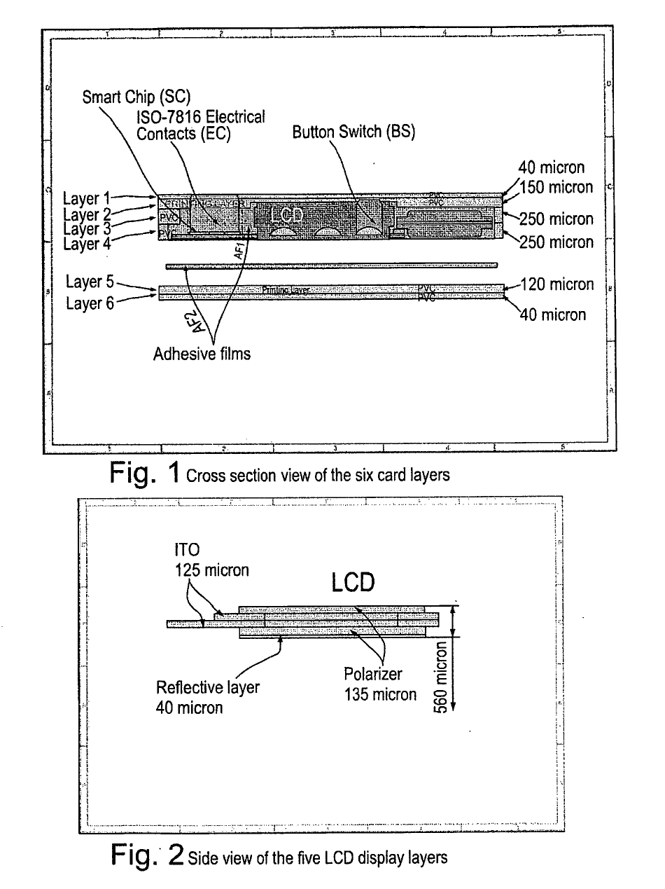

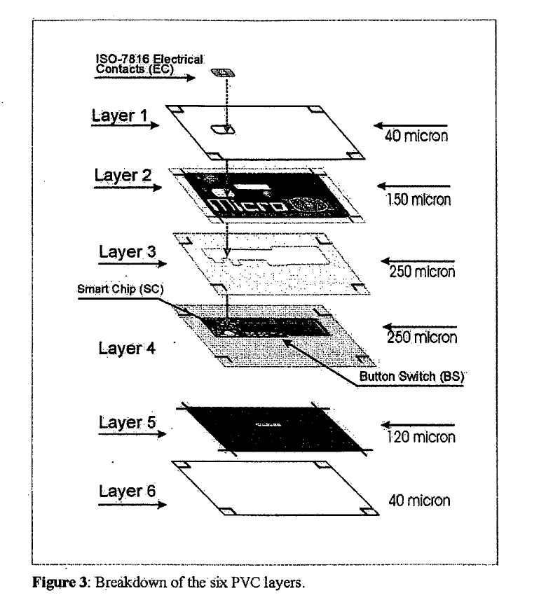

As shown in FIGS. 1 and 3, the illustrated smart card includes six layers 1-6 of polyvinyl chloride of the same outside dimensions but of different thicknesses, as will be described more particularly below. The smart card further includes a PCB having an LCD thereon, in addition to the discrete electrical components and a battery, all embedded within the six laminated plastic layers. Also embedded within the six-layer lamination are a smart chip (SC) and a button switch (BS) electrically connected to the PCB. The electrical contacts EC ISO-7816 are applied over the outer surface of the card.

In the preferred embodiments of the invention described below, layer 1 is 40 microns in thickness and transparent to protect the digital printing and for brightening; layer 2 is 150 microns in thickness and transparent for the LCD display and upper digital printing; layer 3 is 250 microns in thickness, and formed with a cavity for receiving the upper part of the PCB and its LCD display; layer 4 is also 250 microns in thickness, white, and formed with a cavity for receiving the lower part of the PCB; layer 5 is 120 microns in thickness, white, to receive digital printing on the lower face of the smart card; and layer 6 is 40 microns in thickness and transparent to protect the digital printing on layer 5 at the lower face of the card.

The six above layers are laminated together in a two-step lamination process, as will be described more particularly below. When all the layers are laminated together in the finished smart card, the total thickness of the finished smart card is equal to the sum of the thicknesses of each of the six layers, namely 850 microns, which is within the thickness tolerances of the ISO-7816 standard.

The six plastic layers 1-6 illustrated in FIGS. 1 and 3 are laminated together to form the complete smart card laminate, with the PCB and LCD, as well as the smart chip SC and button switch BS embedded therein, in a two-step lamination process, as follows.

First, an initial laminate is produced by subjecting plastic layers 1-4 to a relatively high temperature and pressure for a relatively long period of time. In the preferred embodiment of the invention described below, the relatively high temperature is preferably 110-135° C., more preferably 120° C.; the relatively high pressure is 12-15 Kg/cm², more preferably 14 Kg/cm²; and the relatively long time period is preferably 25-35 minutes, more preferably 30 minutes.

Next, a cavity is produced in one face of the initial laminate, namely starting from the outer face of the layer 4, and extending through layers 4 and 3 and slightly into layer 2, as shown in FIG. 1 of the drawings. This cavity is configured and dimensioned to accommodate the PCB and the LCD carried by the PCB.

Before the PCB and its LCD are introduced into the cavity formed in layers 4, 3 and partly in 2, a film of a solid adhesive AF₁ is applied to cover the outer face of layer 4 and to extend within the cavity.

Then the PCB and its LCD are introduced into the cavity, and pressed against the adhesive film AF₁ so as to firmly engage all the outer surfaces of the PCB and the LED. Preferably, a second film of a solid adhesive AF₂ is then applied to cover the outer surface of first adhesive film AF₁ and to underlie the PCB. The two plastic layers 5 and 6 are then applied over the two adhesive films AF₁, AF₂ of the initial laminate.

With plastic layers 5 and 6 applied over the initial laminate of layers 1-4, the initial laminate, plastic layers 5 and 6 are then laminated to the initial laminate of layers 1-4 by applying heat and pressure to thereby produce the finished smart card having a six-layer lamination with the PCB and LCD embedded therein. This second lamination step, for bonding layers 5 and 6 to the initial laminate of layers 1-4, is effected by applying heat to layer 6 at a lower temperature, at a lower pressure, and for a shorter time period, than used for producing the initial laminate of layers 1-4. In the described preferred embodiments, this lower temperature of laminating layers 5 and 6 to the initial laminate of layers 1-4 is preferably 90-105° C., more preferably 100° C.; the lower pressure is preferably 0.3-0.8 Kg/cm², more preferably 0.5 Kg/cm²; and the time period is preferably 0.3-0.8 minutes, more preferably 0.5 minutes.

It will thus be appreciated that the above-described two-step lamination procedure subjects the heat-sensitive LCD to a significantly lower temperature, to a lower pressure, and for a shorter time period, than would be required in the normal lamination process, thereby substantially reducing the possibility of damaging or destroying the heat-sensitive LCD. The possibility of damaging the LCD is further reduced by the fact that heat applied in the second lamination step, bonding layers 5 and 6 to the initial laminate of layers 1-4, is applied to the opposite side of the PCB carrying the LCD.

The thicknesses of the two adhesive film layers AF₁, AF₂ is preferably 40-60 microns each, more preferably 50 microns, which is sufficient to bond the plastic layers to each other, and also to fill the voids around the PCB and LCD, and thereby to produce a bubble-free finished lamination.

The printed information may be incorporated into the produced smart card by printing on the outer face of layer 2 before bonding layer 1 thereover in the first laminating operation producing the initial laminate of layers 1-4. Thus, layer 1 in the initial laminate acts to protect the printing on the outer face of layer 2.

In addition, information may also be printed on the outer face of layer 5 before that layer is bonded with layer 6 to the initial lamination in the second lamination step, such that layer 6 protects the printing appearing on the outer face of layer 5.

After the six layers 1-6 have been laminated together in the above-described two-step lamination procedure, a groove or recess may be cut through layers 1, 2 and 3 for receiving electrically-conductive strips serving as the electrical contacts EC of the smart card. This may be done by milling the complete laminate up to a conductive surface of the PCB, applying a conductive adhesive to the electrical contacts EC, at least at the portion to engage the PCB, and inserting the electrical contacts into the so-formed grooves, with electrical continuity established between the contacts and PCB via the electrically-conductive adhesive.

FIG. 2 illustrates the construction of the LCD display, wherein it will be seen that it comprises two PET (polyethylene terathyalate) layers, two optically clear (OC) coatings on indium tin oxide (ITO) polyester films, (with a resistance of 50 to 100 ohms/sq, and optical anisotropic property), and one reflective layer. Such an LCD structure has been found to be particularly useful in the above-described smart card and capable of withstanding the temperature and pressure used in the second lamination operation where layers 5 and 6 are laminated to the previously-laminated layers 1-4, with the PCB and LCD embedded therein. As described above, the LCD is not subjected to the higher temperature and pressure during the first lamination process in producing the initial laminate, but only to the lower temperature and pressure, as well as the substantially shorter time period, involved in the second lamination operation, wherein layers 5 and 6 are laminated to the initial laminate of layers 1-4. In addition, since the heat used in the second lamination operation is applied to the underface of the PCB, i.e., the face remote from the LCD, there is less chance of damaging or destroying the LCD during this second lamination operation.

The above-described method is characterized by the following table.

| | | | # of adhesive | | |
|---|---|---|---|---|---|
| | | # of PVC | layers- | Lamination | |
| Step | Process | layers | 50 microns | conditions | Remarks |
| 1 | Pressing 4 upper | 1, 2, | | T = 120° C. | Layer 2 with |
| | layers and Milling of | 3, 4 | | P = 14 kg/cm² | upper digital |
| | layers 3, 4 | | | T = 30 mins | printing |
| 2 | Mill cavity thru one | | | | |
| | face of initial laminate | | | | |
| | of layers 3, 4 | | | | |
| 3 | Adhesive fill of gaps | 3, 4 | | | |
| 4 | Insertion of upper | 3, 4 | | | |
| | PCB and components | | | | |
| 5 | Adhesive application | 4 | 1 | | |
| | at the bottom of PCB | | | | |
| 6 | Placing of 2 lower | 5, 6 | | | Layer 5 with |
| | layers | | | | lower digital |
| | | | | | printing |
| 7 | Lamination of all | 1, 2, | | T = 100° C. | Bottom heat to |
| | layers | 3, 4, | | P = 0.5 kg/cm² | protect LCD |
| | | 5, 6, | | T = 0.5 mins | display |
| 8 | Milling for ISO-7816 | 1, 2 | | | |
| | contacts | | | | |
| 9 | ISO-7916 contacts | | Conducting | | |
| | attachment to PCB | | adhesive | | |
| | leads | | | | |

While the invention has been described with respect to several preferred embodiments, it will be appreciated that these are set forth merely for purposes of example, and that many other variations, modifications and applications of the invention may be made.

What is claimed is:

1. A method of making a thin flexible smart card having a printed circuit board (PCB) including a liquid crystal display (LCD) thereon, said PCB and LCD thereon being embedded within a laminate of plastic layers, comprising:
producing an initial laminate by subjecting a plurality of plastic layers to a relatively high temperature and pressure for a relatively long period of time;
producing a cavity in one face of said initial laminate, but terminating short of the opposite face, said cavity being configured and dimensioned to accommodate said PCB and LCD thereon;
introducing said PCB and said LCD into said cavity from said one face of the initial laminate with the LCD facing said opposite face thereof;
applying one or more further plastic layers over said one face of the initial laminate to cover said PCB in said cavity;
and subjecting said initial laminate and said one or more further plastic layers to a low temperature, applied to the side of said further plastic layers, at a lower pressure and for a shorter period of time than used in producing the initial laminate, to produce said laminate of plastic layers with said PCB and LCD embedded therein.

2. The method according to claim 1, wherein a film of a solid adhesive is applied to said one face of the initial laminate, before said PCB and LCD are introduced into said cavity, to extend into said cavity between the surfaces thereof and said PCB and LCD when introduced therein; said film of solid adhesive being of a thickness to bond said one or more plastic layers to said one face of the initial laminate, and to fill voids between said PCB, LCD and the surfaces of said cavity, when said initial laminate and said one or more further plastic layers are subjected to said lower temperature and pressure for said shorter period of time.

3. The method according to claim 2, wherein a second film of a solid adhesive is applied to said one face of the initial laminate, before said PCB and LCD are introduced into said cavity, to extend between the outer surface of said PCB and said one or more further plastic layers, said second film of solid adhesive being of a thickness to bond said one or more plastic layers to said one face of the initial laminate, and to fill voids between said PCB and said one or more further plastic layers, when said initial laminate and said one or more further plastic layers are subjected to said lower temperature and pressure for said shorter period of time.

4. The method according to claim 2, wherein said film of a solid adhesive is an acrylic resin.

5. The method according to claim 1, wherein said plastic layers are polyvinyl chloride.

6. The method according to claim 1, wherein said initial laminate is constituted of a first plastic layer of 30-50 microns, a second plastic layer of 135-165 microns, a third plastic layer of 225-275 microns, and a fourth plastic layer of 225-275 microns;
and wherein said one or more further plastic layers include a fifth layer of 105-135 microns, and a sixth layer of 30-50 microns.

7. The method according to claim 1, wherein said initial laminate is constituted of a first plastic layer of 40 microns, a second plastic layer of 150 microns, a third plastic layer of 250 microns, and a fourth plastic layer of 250 microns;
and wherein said one or more further plastic layers include a fifth layer of 120 microns, and a sixth layer of 40 microns.

8. The method according to claim 1, wherein said relatively high temperature is 110-135° C., said relatively high pressure is 12-16 Kg/cm², and said relatively long time period is 25-35 minutes;
and wherein said lower temperature is 90-105° C., said lower pressure is 0.3-0.8 Kg/cm², and said shorter time period is 0.3-0.8 minutes.

9. The method according to claim 8, wherein said relatively high temperature is 120° C., said relatively high pressure is 14 Kg/cm², and said relatively long time period is 30 minutes;
and wherein said lower temperature is 100° C., said lower pressure is 0.5 Kg/cm², and said shorter time period is 0.5 minutes.

10. The method according to claim 1, wherein said produced laminate of plastic layers, with said PCB and LCD embedded therein, is milled on one face with mills communicating with said PCB; and wherein electrical contact strips coated with an electrically conductive adhesive are applied in said mills and electrically connected to said PCB via said electrically-conductive adhesive.

11. The method according to claim 1, wherein said PCB further includes a button switch electrically connected to said PCB and embedded therewith in said produced laminate.

12. The method according to claim 1, wherein said PCB further includes a smart chip electrically connected to said PCB and embedded therewith in said produced laminate.

13. The method according to claim 1, wherein said LCD included on said PCB comprises two PET (polyethylene terathyalate) layers, two optically clear (OC) coatings on indium tin oxide (ITO) polyester films (with a resistance of 50 to 100 ohms/sq, and optical anisotropic property), and one reflective layer.

14. A thin flexible smart card, comprising:
a laminate of plastic layers, and a PCB including an LCD thereon, both embedded within said laminate of plastic layers;
said LCD comprising: two PET (polyethylene terathyalate) layers, two optically clear (OC) coatings on indium tin oxide (ITO) polyester film, with a resistance of 50 to 100 ohms/sq, and optical anisotropic property, and one reflective layer.

15. An LCD, comprising: two PET (polyethylene terathyalate) layers, two optically clear (OC) coatings on indium tin oxide (ITO) polyester films with a resistance of 50 to 100 ohms/sq, and optical anisotropic property, and one reflective layer.
